(19) United States
(12) Patent Application Publication
(10) Pub. No.: US 2008/0297443 A1
(43) Pub. Date: Dec. 4, 2008

(54) Plasma display apparatus

(76) Inventors: Tomoyuki ARIMA, Yokohama (JP); Yoshiro MURAYASU, Yokohama (JP)

Correspondence Address: MCDERMOTT WILL & EMERY LLP, 600 13TH STREET, N.W., WASHINGTON, DC, 20005-3096, US

(21) Appl. No.: 11/907,526

(22) Filed: Oct. 12, 2007

(30) Foreign Application Priority Data
May 31, 2007 (JP) 2007-145518

(51) Int. Cl. G09G 3/28

(52) U.S. Cl. 345/60

(57) ABSTRACT

A plasma display apparatus is disclosed that includes a panel substrate, a chassis adhered to a rear surface of the panel substrate and supporting the panel substrate, and plural address driver modules arranged along a rim portion of the panel substrate. Each address driver module including a flexible board and an address driver circuit provided on the flexible board and having one end fixed to a front surface rim part of the panel substrate. The chassis has plural through-holes formed in a rim part of the chassis. The plural through-holes expose a part of the panel substrate to which plural attachment parts are fixed. The plural attachment parts include adjacently arranged attachments parts fixed to the panel substrate by a coupling part. The other end of each address driver module is fixed to the corresponding attachment part.

### BACKGROUND OF THE INVENTION

1. Field of the Invention

The present invention generally relates to a plasma display apparatus known as a flat type display device, and more particularly to a method for having an address driver module(s) fixed in a plasma display apparatus.

2. Description of the Related Art

Conventionally, as a known flat type display panel, there is a plasma display apparatus that uses a plasma display panel. FIG. 11 is a schematic diagram showing an electrode array of a conventionally used plasma display panel 130. In FIG. 11, a matrix configuration of M lines×N columns is formed by scan electrodes SCN1 to SCNM and address electrodes D1 to DN. That is, M lines of the scan electrodes SCN1 to SCNM are arranged in the line direction, and N columns of the address electrodes D1 to DN are arranged in the column direction. In the plasma display panel 130 having such an electrode configuration, discharge cells are selected by conducting address discharge by applying write pulses between the address electrodes D1 to D N and the scan electrodes SCN1 to SCNM. Then, a predetermined display can be shown by conducting sustain discharge by applying alternately inverting periodic sustain pulses between the scan electrodes SCN1 to SCNM and the sustain electrodes SUS1 to SUSM. Since display on the plasma display panel 130 is performed with the above-described discharging operation, a plasma display apparatus is configured having, for example, an address driver circuit (not shown), a scan driver circuit (not shown), a sustain driver circuit (not shown), a power supply circuit (not shown), and a control circuit (not shown).

In the plasma display apparatus having such configuration, plural address driver circuit blocks corresponding to the number of pixels of the plasma display panel 130 are required. There is a known method of using a flexible board for the address driver circuit block, for example, shown in Japanese Laid-Open Patent Application No. 2004-258473.

FIG. 12 is a cross-sectional view showing a configuration of a conventional plasma display apparatus 200 using a flexible board 111 as an address driver circuit block. In FIG. 12, the plasma display panel 130 is retained by having the plasma display panel 130 adhered to a front surface of a chassis member 140 (formed of, for example, aluminum) via a thermal conduction sheet 142. Further, plural drive circuit blocks 160 serving to drive the display of the plasma display panel 130 are attached to a rear surface of the chassis member 140. The drive circuit block 160, which includes an electric circuit for driving the display of the plasma display panel 130 and controlling the driving of the display, has an electric connecting part provided on its end part so that electrodes arranged at the respective rim parts of the plasma display panel 130 can electrically connect to plural flexible boards 111 extending over the rim parts that form the four sides of the chassis member 140. That is, the flexible board 111 provides electric connection by bending 180 degrees from the front surface side to the rear surface side of the plasma display panel 130. A driver IC 112, which is configured as the address driver circuit, is mounted on an inner surface of the bent flexible board 111. Plural driver ICs 112, serving to supply display data to address electrodes of the plasma display panel 130, are connected to the plasma display panel 130. A metal (e.g., aluminum) heat sink 113 serving as a retaining plate is adhered to a surface of the flexible board 111 opposite of the surface on which the driver IC 112 is mounted. Thereby, the electrodes of the plasma display panel 130 and the driving circuit blocks provided on opposite sides are electrically connected by the bending flexible board 111.

FIG. 13 is a perspective view showing the plasma display apparatus 200 of FIG. 12 observed from the chassis member 140 side. In FIG. 13, the chassis member 140 includes a positioning boss part 120a and an attachment boss part 120. The flexible board 111 is disposed in a manner bending from the front surface of the plasma display panel 130 to the chassis member 140. The positioning boss part 120a has a positioning pin 123 provided at its tip. Positioning is realized by inserting the positioning pin 123 into a through-hole 114 provided at a front rim part of the heat sink 113. Further, the attachment boss 120 is fixed to the heat sink 113 by having its attachment screw 125 fastened to the heat sink 113. In fixing the address driver circuit block to the chassis member 140 (made of, for example, aluminum), the workload (difficulty) of fastening the attachment boss part 120 to the attachment screw can be reduced by having either one of the two boss parts 120, 120a configured as a positioning boss (in this example, the positioning boss part 120a). Thereby, workability of assembly can be improved.

However, with the configuration described in Japanese Laid-Open Patent Application No. 2004-258473, the bent flexible board 111 is fixed by fixing one end to the plasma display panel 130 (made of, for example, glass) and the other end to the chassis member 140 (made of, for example, aluminum) via the heat sink 113, and the boss parts 120, 120a. Where the heat generated in the plasma display panel 130 is transmitted to the chassis member 140 via an adhesive layer 142 having high heat transferability, the amount of deformation exhibited by the thermal expansion of the plasma display panel 130 is different from the amount of deformation exhibited by the thermal expansion of the chassis member 140 since glass and aluminum have different thermal expansion coefficient. Accordingly, in the configuration described in Japanese Laid-Open Patent Application No. 2004-258473, due to the difference in the amount of deformation of the parts that fix the flexible board 111, stress is applied to the fixing parts. This leads to the risk of the creation of cracks and fracture.

### SUMMARY OF THE INVENTION

The present invention may provide a plasma display apparatus that substantially obviates one or more of the problems caused by the limitations and disadvantages of the related art.

For example, one object according to an embodiment of the present invention is to provide a plasma display apparatus having a high heat resisting property and preventing thermal expansion from causing application of stress to a flexible board having an address driver circuit mounted thereon.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a plasma display apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a plasma display apparatus including a panel substrate, a chassis adhered to a rear surface of the panel substrate and supporting the panel substrate, and plural address driver modules arranged along a rim portion of the panel substrate, each address driver module including a flexible board and an address driver circuit provided on the flexible board and having one end fixed to a front surface rim part of the panel substrate, wherein the chassis has at least one through-hole formed in a rim part of the chassis, the through-hole exposing a part of the panel substrate to which plural attachment parts are fixed, the plural attachment parts including adjacently arranged attachments parts fixed to the panel substrate by a coupling part, wherein the other end of the address driver module is fixed to the plural attachment parts.

Additional objects, advantages and novel features of the examples will be set forth in part in the description which follows, and in parts will become apparent to those skilled in the art upon examination of the following and the accompanying drawings or may be learned by production or operation of the examples. The objects and advantages of the inventive concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic view showing a plasma display apparatus 100 according to an embodiment of the present invention;

FIG. 2 is a diagram showing an example of drive waveforms of the plasma display apparatus shown in FIG. 1;

FIG. 3 is a plan view showing a rear surface of the plasma display panel 90 toward the chassis 40 side according to an embodiment of the present invention;

FIG. 4 is a perspective view showing a case where a single address driver module 10 is fixed to a chassis according to an embodiment of the present invention;

FIG. 5 is an enlarged cross-sectional view showing a part where an attachment part 20 is fixed to an exposed part of a panel substrate 30 according to an embodiment of the present invention;

FIG. 6 is a schematic diagram for describing an exemplary case of connecting plural adjacently arranged address driver modules 10 in a plasma display apparatus 100 according to an embodiment of the present invention;

FIG. 7 is a side view showing a plasma display apparatus 100 according to an embodiment of the present invention;

FIG. 8 is a perspective view showing attachment parts 20 and a coupling part in a plasma display apparatus 100a according to another embodiment of the present invention;

FIG. 9 is a perspective view showing attachment parts 20 and a coupling part in a plasma display apparatus 100b according to another embodiment of the present invention;

FIG. 10 is a perspective view showing a part for fixing address driver modules 10 in a plasma display apparatus 100c according to another embodiment;

FIG. 11 is a diagram showing an electrode array of a conventional plasma display panel 130;

FIG. 12 is a cross-sectional view showing a configuration of a conventional plasma display apparatus 200; and

FIG. 13 is a perspective view showing a conventional plasma display apparatus 200 observed from a chassis member 140 side.

### DESCRIPTION OF THE PREFERRED EMBODIMENTS

In the following, embodiments of the present invention will be described with reference to the accompanying drawings.

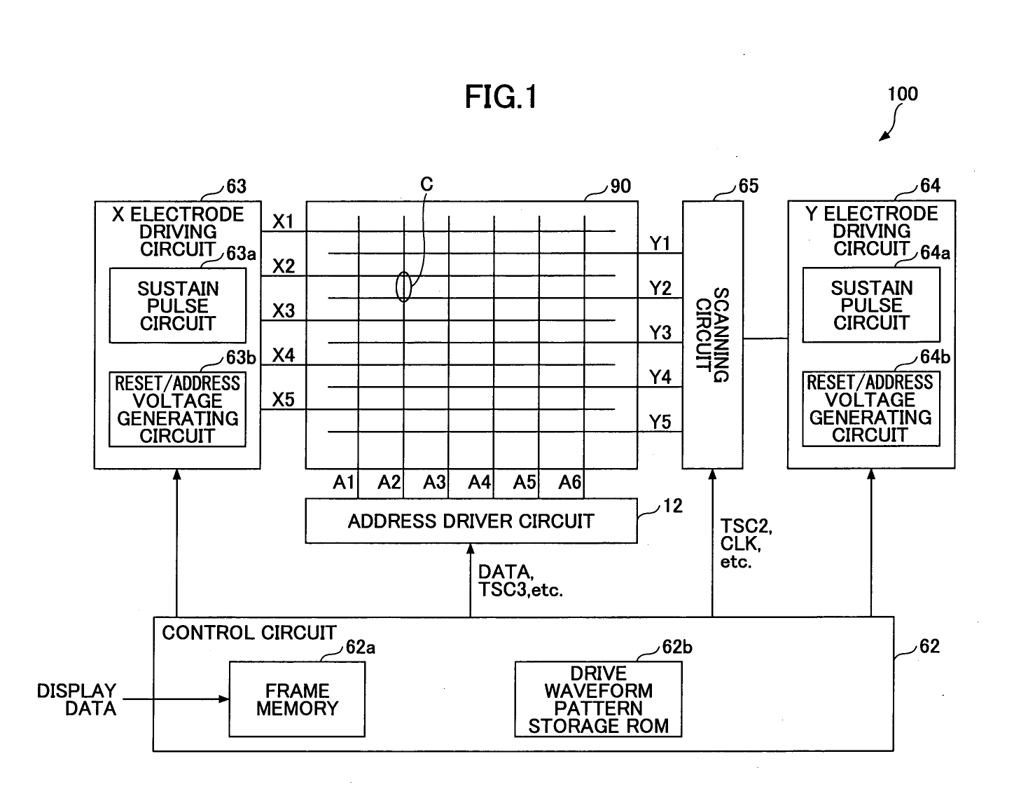

FIG. 1 is a schematic diagram of a plasma display panel apparatus 100 using a three-electrode plasma display panel 90 according to an embodiment of the present invention. In FIG. 1, a cell C is formed at an intersecting point between a pair of adjacent sustain (X) electrode and a scan (Y) electrode and an address electrode. In the example shown FIG. 1, 6×5 cells are formed.

Each address electrode A1-A6 is driven by an address driver circuit 12. Each X-electrode X1-X5 is driven by an X-electrode driving circuit board 63. Each Y-electrode Y1-Y5 is connected to a scanning circuit 65. A Y-electrode driving circuit board 64 is connected to the scanning circuit 65. The X-electrode driving circuit board 63 includes a sustain pulse generating circuit 63a for generating a sustain pulse and a reset/address voltage generating circuit 63b for generating voltage to be applied to the X-electrode during a reset period and an address period. The Y-electrode driving circuit board 64 includes a sustain pulse circuit 64a for generating a sustain pulse and a reset/address voltage generating circuit 64b for generating voltage to be applied to the Y-electrode during a reset period and an address period. During the address period, a scan pulse and a voltage required for scanning are supplied from the Y-electrode driving circuit board 64 to the scanning circuit 65, to thereby cause a shift register installed in the scanning circuit 65 to successively apply a scan pulse to each Y-electrode. During the sustain period, the scanning circuit 65 keeps all of the Y-electrodes connected to the Y-electrode driving circuit board 64, to thereby allow the Y-electrode driving circuit board 64 to apply a predetermined voltage to each Y-electrode.

A control circuit board 62 is a circuit board for controlling each part of the plasma display apparatus 100. The control circuit board 62 includes, for example, a frame memory 62a for converting display data received from outside into data adaptable for subfields, and a ROM 62b for storing reference waveform patterns for generating drive waveforms. The control circuit board 62 outputs, for example, display data signals DATA of each subfield and timing control signals TSC3 for controlling the timing of outputting address pulses to the address driver circuit 12. Further, the control circuit board 62 also outputs, for example, controls signals TSC2 for controlling the timing and length of outputting scan pulses and shift clock signals CLK to the scanning circuit 65.

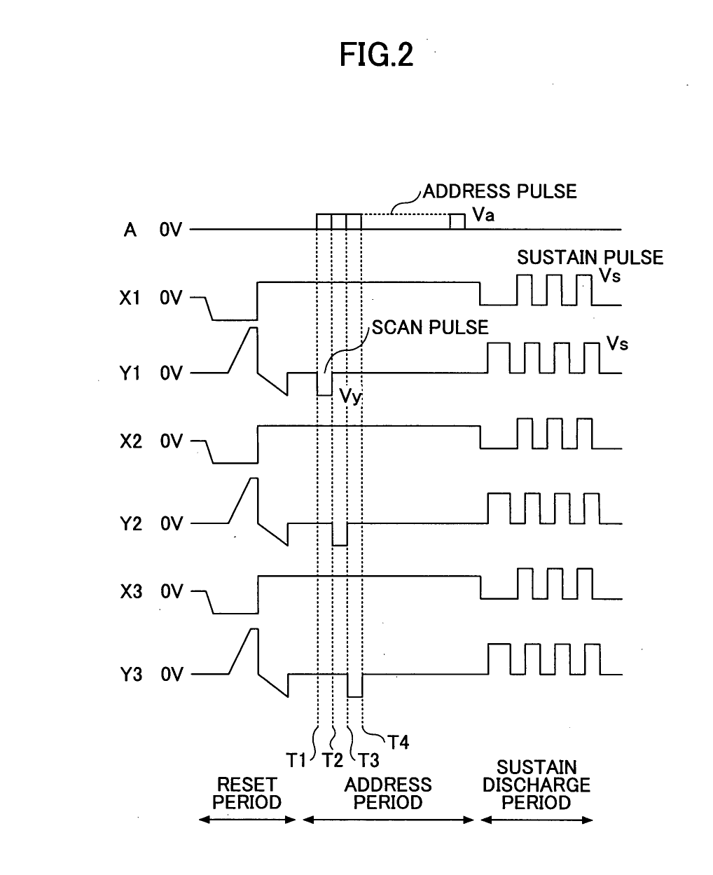

FIG. 2 is a schematic diagram for showing examples of waveforms of each subfield of the plasma display apparatus 100 shown in FIG. 1. During the reset period, the address electrode is supplied with a pulse (voltage) of 0 V. Further, as shown in X1 of FIG. 2, the pulse applied to each X-electrode maintains a predetermined voltage after gradually changing toward the negative side, and then changes to a predetermined positive voltage. Further, as shown in Y1 of FIG. 2, the pulse (voltage) applied to the Y-electrode gradually changes toward the negative side after temporarily changing to 0 V and gradually changing toward the positive side. Thereby, reset discharge occurs among all of the X-electrodes and the Y-electrodes so that all of the cells become a uniform state. During the address period, as shown in X2 of FIG. 2, the pulse applied to all X-electrodes maintains a predetermined positive voltage. Meanwhile, the Y-electrodes are successively applied with a scan pulse having a voltage of −Vy. In synchronization with the application of the scan pulse of −Vy, an address pulse having a voltage of Va is applied to the address electrodes. Thereby, address discharge occurs in the cells which have been simultaneously supplied with the scan pulse and the address pulse. During the sustain discharge period, the address electrodes are supplied with a pulse of 0 V. Meanwhile, the X-electrodes and the Y-electrodes are alternately applied with a sustain pulse having a voltage of Vs. Thereby, sustain discharge occurs in the cells where address discharges have occurred so that areas corresponding to the cells are lit for display.

It is to be noted that the above-described embodiment of the present invention may also be applied to other configurations and waveforms besides the exemplary configuration and drive waveforms of the plasma display apparatus 100 shown in FIGS. 1 and 2. That is, since the plasma display apparatus 100 according to an embodiment relates to a methodology of fixing a plasma display panel 90 to an address driver module (not shown) having an address driver circuit 12 mounted thereon, the above-described embodiment of the present invention can be applied to, for example, other circuit configurations and drive waveforms.

Next, a configuration of components attached to a chassis 40 provided on a rear surface of a plasma display panel 9 of the plasma display apparatus 100 having the above-described circuit configuration is described.

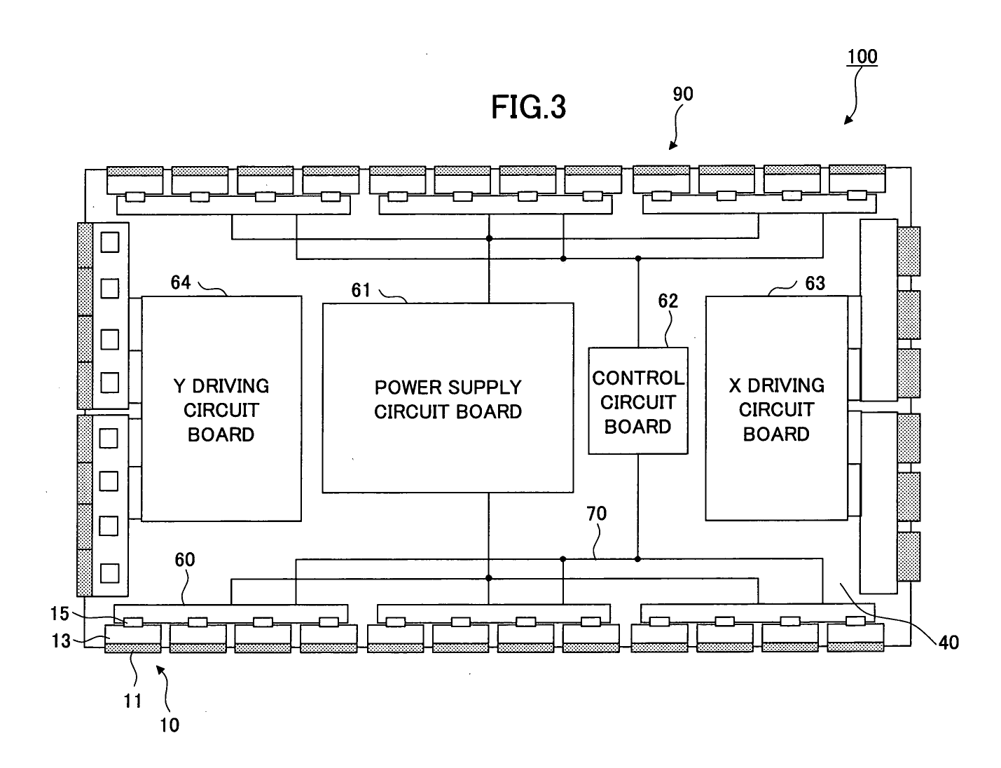

FIG. 3 is a plan view showing the configuration from the chassis 40 side (rear side) of the plasma display panel 90 according to an embodiment of the present invention. In FIG. 3, a power supply circuit board 61, a control circuit board 62, an X-electrode driving circuit board 63, and a Y-electrode driving circuit board 64 are provided on a center part of the chassis 40. Further, plural address electrode drive control circuit boards 60 are arranged from top to bottom in the vicinity of the outer rim parts in a longitudinal direction of the chassis 40. In the example shown in FIG. 3, three address electrode drive control circuit boards 60 are provided on each longitudinal side (upper side, lower side) of the chassis 4. Each address electrode drive control circuit board 60 is connected to the power supply circuit board 61 and the control circuit board 62 by connection wiring 70. Thereby, the address electrode drive control circuit board 60 receives power from the power supply circuit board 61 and control commands from the control circuit board 62 for driving the address electrodes A1-A6.

Plural address driver modules 10 are arranged at an outer peripheral rim part (rim part) of the upper and lower sides of the chassis 40 in a longitudinal direction of the plasma display panel 90. The address driver module 10 includes a flexible board 11 having a driver circuit (not shown) including a driver IC (not shown) mounted thereon and a retaining board 13 for retaining a tip part of the flexible board 11. The tip part of the flexible board 11 is configured as a connector part 15 for electrically connecting with the address electrode control circuit board 60. The flexible board 11 is a wiring board having a flexible bending property. The flexible board 11 is made of, for example, a resin material such as polyimide. In addition to having a driver IC provided on the surface of the flexible board 11, conductor wiring may also be provided for allowing its terminal part to be electrically connected with the driver IC. In FIG. 3, the address electrode drive control circuit board 60 and the address electrode(s) can be electrically connected, by connecting the connector part 15 of the flexible board 11 to the address electrode drive control circuit board 60 by fixing (e.g., crimping) a terminal part of an address electrode (not shown) provided at an outer rim part of a panel substrate (not shown) fixed (e.g., by using an adhesive) to a rear surface of the chassis 40, to a terminal part of the flexible board 11 and bending the flexible board 11 toward the chassis 40 side.

In a case of performing address discharge with the plasma display apparatus 100 having the foregoing configuration, controls signals are sent from the control circuit board 62 to each address electrode drive control circuit board 60 for enabling addresses to be selected by having each address electrode drive control circuit board 60 operate each address driver circuit 12 of the corresponding address driver modules 10. In this case, as described above with reference to FIGS. 1 and 2, displaying of the plasma display panel 90 is performed by determining the position of discharge cells by operating the Y-electrode driving circuit board 64 and then performing sustain discharge by driving both the X-electrode drive circuit board 63 and the Y-electrode drive circuit board 64. Since the X-electrode and the Y-electrode are arranged substantially parallel to the longitudinal direction of the plasma display panel 90, the driver IC, which supplies current to the X and Y electrodes, is arranged along a rim part (left and right sides in FIG. 3) with respect to a transverse direction of the plasma display panel 90. Meanwhile, since the address electrodes are arranged substantially parallel to the transverse direction of the plasma display panel 90, the address driver modules 10, which drive the address electrodes, are arranged along a rim part (upper and lower sides in FIG. 3) with respect to the longitudinal direction of the plasma display panel 90. It is to be noted that, in FIG. 3, although the address driver modules 10 are arranged on both the upper and lower sides of the plasma display panel 90, the address driver modules 10 may alternatively be arranged on either one of the upper and lower sides depending on the number of electrodes.

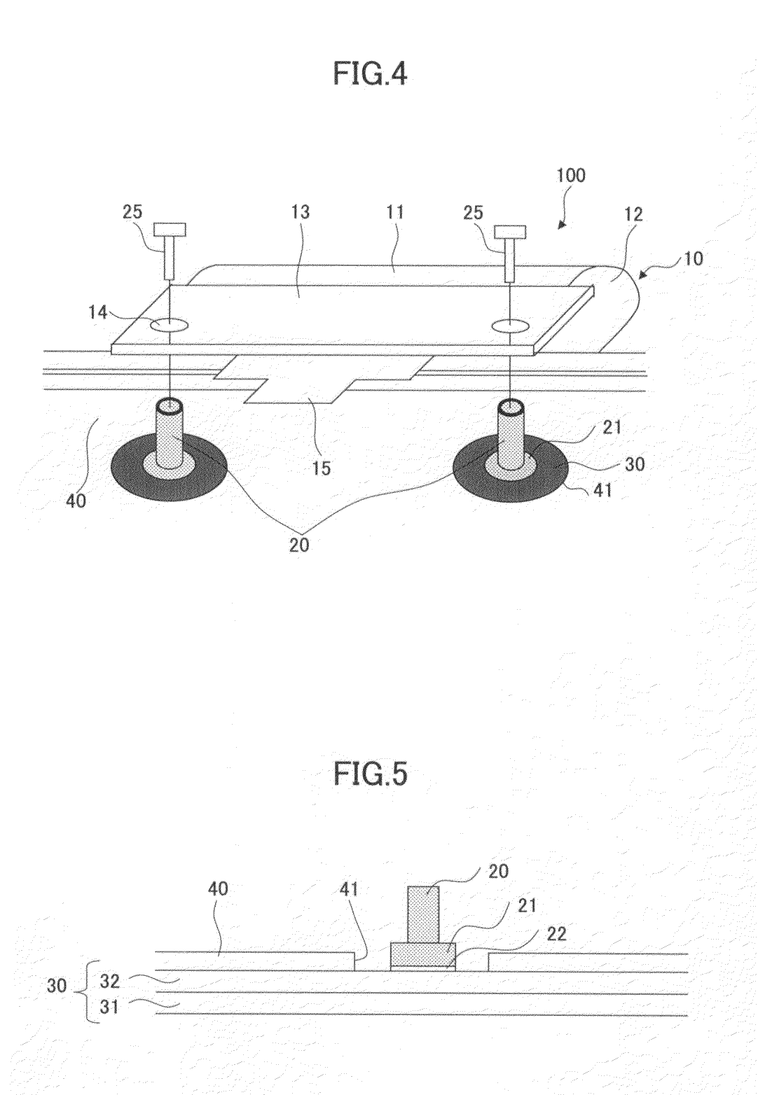

Next, a method of fixing each address driver module 10 to the chassis 40 of the plasma display apparatus 100 according to an embodiment of the present invention is described with reference to FIG. 4. FIG. 4 is a perspective view showing a relationship between the address driver module 10 and the chassis 40 in a case of fixing a single address driver module 10 to the chassis 40.

FIG. 4 shows where through-holes 41 are formed in a portion of the chassis 40, and the panel substrate 30 constituting the plasma display panel 90 has its rear surface exposed. It is to be noted that “rear surface” according to an embodiment of the present invention refers to a non-display surface provided on the back side of plasma display panel 90 in a case where “front surface” refers to the front surface of the plasma display panel 90. The panel substrate 30 is formed of, for example, glass. In such case, the material of the exposed part of the panel substrate 30 is also formed of glass. The plasma display apparatus 100 according to an embodiment of the present invention has an attachment part 20 having one end fixed to the exposed part of the panel substrate 30. Further, the other end of the attachment part 20 is fixed to the retaining board 13 provided in the vicinity of the tip of the address driver module 10 by inserting corresponding screws 25 into two through-holes 14 of the retaining board 13 and fastening the screws 25 to the other end of the attachment part 20. The address driver circuit 12 including, for example, a driver IC, is provided on the flexible board 11 of the address driver 10. The tip of the flexible board 11 is formed as the connector part 15.

Accordingly, in the plasma display apparatus 100 according to an embodiment of the present invention, there is a target object by which the address driver modules 10 are uniformly fixed to the rear surface of the panel substrate 30, for example, by having one end attached to the front surface rim part of the panel substrate 30 and the other end attached to the attachment part 20. Accordingly, the thermal deformation property received by the address driver modules 10 from the target object is substantially the same (uniform).

In other words, in a case where the plasma display panel 90 is heated by discharge, the heat causes thermal expansion with respect to components surrounding the plasma display panel 90 and slightly deforms the components. For example, with reference to FIG. 4, both the panel substrate 30 and the chassis 40 supporting the panel substrate 30 thermally expand and deform. The heat directly affects the panel substrate 30 whereas the heat is indirectly transferred to the chassis 40 via, for example, double-face adhesive tape or an adhesive agent for adhering the panel substrate 30. Nevertheless, both the panel substrate 30 and the chassis 40 receive substantially the same amount of heat since the adhesive agent and the double-face adhesive tape have high thermal conductivity. In this embodiment of the present invention where the panel substrate 30 is made of glass and the chassis 40 made of aluminum, the thermal expansion coefficient of glass is 8.5 (×10⁻⁶/° C.) and the thermal expansion coefficient of aluminum is 23 (×10⁻⁶/° C.). Thus, the thermal expansion coefficient of aluminum is approximately three times greater than that of glass. Therefore, in a case where the plasma display panel 90 generates a large amount of heat, the chassis 40 made of aluminum deforms significantly whereas the panel substrate 30 made of glass deforms very little. In such a situation, since the attachment part 20 is fixed to the chassis 40 having a high thermal expansion coefficient, the space between the attachment parts 20 widens and the attachment parts 20 deform in a manner significantly shifting toward the outer side of the plasma display panel 90. Thus, a similar amount of stress is also applied to the retaining board 13 of the address driver module 10. Meanwhile, at the other end of the address driver module 10, the flexible board 11 is directly fixed to the panel substrate 30. Thus, the stress received from the deformation of the panel substrate 30 is significantly smaller than that received from the deformation of the chassis 40. This results in the generation of a force pulling the flexible board 11 away from the chassis 40 toward the outer side of the plasma display panel 90 as well as in the longitudinal direction of the plasma display panel 90. Therefore, the joint (connecting) parts between the address electrodes and the flexible board 11 are liable to break (fracture). Furthermore, since aluminum has a high thermal expansion coefficient, the joint (connecting) parts between the attachment parts 20 and the retaining board 13 are also liable to break (fracture).

Therefore, in the plasma display apparatus 100 according to an embodiment of the present invention, the amount of deformation due to heat is reduced by fixing the attachment parts 20 to the panel substrate 30 made of a material having a low thermal expansion coefficient (e.g., glass). In addition, the stress applied to the target fixing object from the deformation can be made uniform by having the panel substrate 30 serve as the target fixing object of the address driver modules 10, in other words, by fixing the address driver modules 10 to the same panel substrate 30. Accordingly, the address driver modules 10 can be prevented from breakage (fracture) due to heat.

It is to be noted that various embodiments can be used for the attachment part 20 as long as it has a configuration (e.g., material or shape) capable of having one end of the attachment part 20 securely fixed to the panel substrate 30 (made of glass, for example) and the other end fixed to the address driver module 10. For example, the material of the attachment part 20 may be brass, aluminum, and/or iron. Further, in FIG. 4, the attachment part 20 is illustrated as having a circular cylindrical hollow body capable of, for example, receiving and having fastened a screw thereinto. Nevertheless, the attachment part 20 may take other shapes as long as it can fix the address driver modules 10 and maintain a predetermined relationship between the address driver modules 10 and the chassis 40. For example, the attachment part 20 may be shaped as a circular cylindrical solid having its upper part fixed (e.g., crimped or adhered) to the retaining board 1 of the address driver module 10. In another example, the attachment part 20 may be formed with a square cross section and threaded at its center for fixing (fastening) with the screw 25. In the embodiment shown in FIG. 4 (also in below-described FIG. 5), in addition to a circular hollow cylinder body, the attachment part 20 has a circular seat 21 provided at a part contacting the panel substrate 30. The circular seat 21 of the attachment part 20 is formed wider than the cylinder body so that the area contacting the panel substrate 30 can be broadened, to thereby increase stability with respect to the panel substrate 30. Furthermore, although two attachment parts 20 are provided to a single address driver module 10 in the embodiment shown in FIG. 4, the number of attachment parts 20 provided to a single address driver module 10 may be altered according to usage.

Furthermore, the retaining board 13 may be made of a material having high heat conductivity (e.g., aluminum) so that the retaining board 13 can also serve as a heat sink. Furthermore, the through-holes 14 formed in the retaining board 13 may have an elliptical shape for increasing resistance to stress in the longitudinal direction (horizontal direction). This reduces the risk of the retaining board 13 being broken (fractured) by the stress in the horizontal direction. It is to be noted that, although the retaining board 13 is used for easy attachment of the attachment parts 20 of the address driver module 10, the retaining board 13 may be omitted, for example, in a case where the material of the flexible board 11 is improved for allowing the flexible board 11 to be directly fixed to the attachment parts 20.

FIG. 5 is an enlarged cross-sectional view showing a part where the attachment part 20 is fixed to an exposed part of the panel substrate 30. In FIG. 5, the panel substrate 30 including a front surface part 31 and a rear surface part 32 is fixed to the chassis 40. It is to be noted that the panel substrate 30 according to an embodiment of the present invention may be adhesively fixed to the chassis 40 by using an adhesive agent or a double-face adhesive tape. A through-hole 41 is formed in the chassis 40 for exposing a portion of the rear surface part 32. The attachment part 20 is fixed to (supported by) the exposed portion of the rear surface part 32. The attachment part 20 has the circular seat 21 provided at its bottom part. The bottom of the circular seat 21 is fixed to the exposed portion (toward the chassis 40) of the rear surface part 32 by using, for example, an adhesive part 22 (e.g., double-face adhesive tape, adhesive agent). The attachment part 20 may be fixed to the exposed portion of the rear surface part 32 by using methods other than the above-described adhesive fixing method.

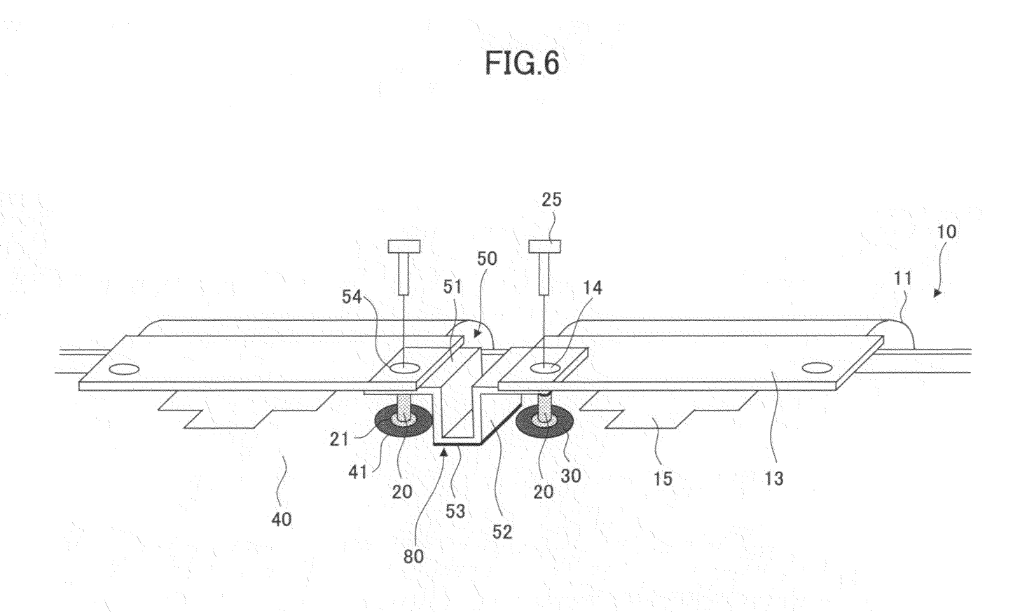

FIG. 6 shows an example of serially fixing adjacent address driver modules 10 of a plasma display apparatus 100 according to an embodiment of the present invention. In FIG. 6, two adjacent address driver modules 10 are provided where each address driver module 10 includes a flexible board 11, a retaining board 13, and a connector part 15. Further, through-holes 14 are formed in the retaining board 13. Further, through-holes 41 are formed in the chassis 40. Portions of the rear surface of the panel substrate 30 are exposed at the through-holes 41. Each attachment part 20 is fixed to a corresponding exposed portion of the panel substrate 30.

Although the configuration of the plasma display apparatus 100 of FIG. 6 is substantially the same as that of FIG. 4, the configuration of FIG. 6 additionally shows a supporting board 50 that couples the retaining boards 13 of adjacent address driver modules 10. The supporting board 50 includes a flat upper part 51, a side part 52, and a bottom part 53. The side part 52 and the bottom part 53 form a U-shaped groove part. Further, through-holes 54 are formed in the flat upper part 51. The supporting board 50 is fixed to the retaining boards 13 by inserting the screw 25 through the through-hole 54 of the flat upper part 51 and the through-hole 14 of the retaining board 13 and fastening the screw 25 to the attachment part 20. The bottom part 53 of the supporting board 50 is in contact with the chassis 40.

With such a configuration, the supporting board 50 serves to couple adjacent attachment parts 20 with each other and reinforce the attachment parts 20. As shown in FIGS. 4-6, the attachment parts 20 are formed with a relatively small size from the aspect of saving space and reducing cost. In such a case the area of the circular base 21 for fixing an attachment part 20 to the exposed portion of the panel substrate 30 is typically reduced. Thus, in some cases, the fixing strength of the attachment part 20 may be insufficient. Therefore, in the plasma display apparatus 100 according to the above-described embodiment of the present invention, the fixing strength of the attachment parts 20 can be reinforced by using the supporting board 50 for coupling adjacent attachment parts 20 together. More particularly, since the supporting board 50 couples the attachment parts 20 adjacently arranged in the longitudinal direction of the panel substrate 30, resistance with respect to force applied in the longitudinal direction can be improved. In a case where the supporting board 50 is mostly used for reinforcement, the supporting board 50 may have a configuration other than a U-shape. For example, the supporting board 50 may simply be formed with a flat shape or a V-shape.

Furthermore, the supporting board 50 can also improve the heat releasing property (heat transferring property). Since heat is also generated in the address driver modules 10, the heat is required to be released (transferred). Since the bottom part 53 of the supporting board 50 is in contact with the chassis 40, the heat can be released (transferred) to the chassis 40, for example, by forming the retaining board 13 and the supporting board 50 with a material having high heat conductivity (e.g., aluminum). In other words, the heat released from the retaining board 13 is transmitted to the flat upper part 51 of the supporting board 50 and released from the bottom part 53 of the supporting board 50 to the chassis 40. As a result, the heat releasing property of the address driver module 10 can be improved.

Furthermore, the supporting board 50 can obtain a large ground area for strengthening ground wiring. Since the bottom part 53 of the supporting board 50 is in contact with the chassis 40, the ground area for ground wiring can be increased, for example, by forming the retaining board 50 and the supporting board 50 with a metal material having high electric conductivity (e.g., aluminum, iron). Thereby, ground characteristics can be improved.

It is to be noted that an electrically conductive gasket 80 may be provided between the bottom part 53 of the supporting board 50 and the chassis 40. This not only increases the air tightness between the bottom part 53 and the chassis 40, improves the heat releasing property, and strengthens ground characteristics, but also improves resistance against compressive load. Thereby, the attachment parts 20 can be further reinforced.

Hence, by using the supporting board 50 to couple adjacent attachment parts 20 together, the plasma display apparatus 100 will not only have high heat resistance but will also have improved heat releasing characteristics and ground characteristics.

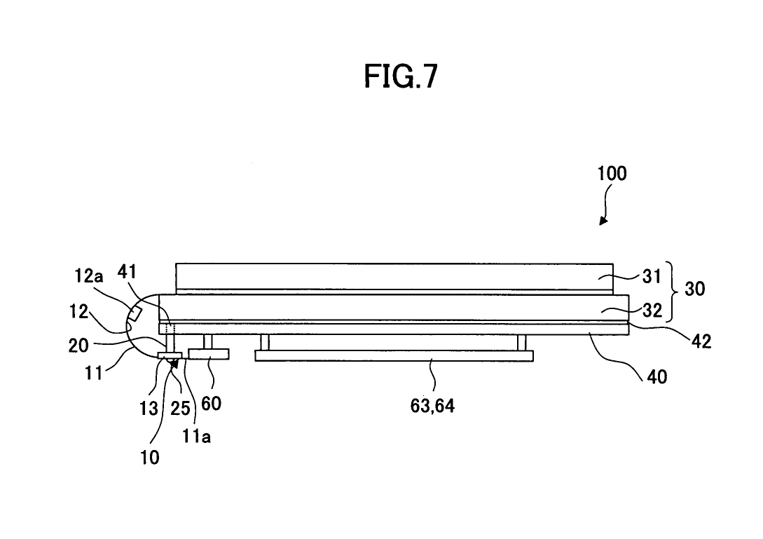

FIG. 7 is a side view of the plasma display apparatus 100 according to an embodiment of the present invention. In FIG. 7, the panel substrate 30 including the front surface part 31 and the rear surface part 32 is fixed to the chassis 40. It is to be noted that the panel substrate 30 according to an embodiment of the present invention may be adhesively fixed to the chassis 40 by using, for example, an adhesive part 40 (e.g., double-face adhesive tape, adhesive agent). The chassis 40 has the X-electrode drive circuit board 63 or the Y-electrode drive circuit board 64 provided at a center part of its surface opposite to the panel substrate 30. Furthermore, the address electrode drive control circuit board 60 and the attachment part 20 are provided at a rim part of the chassis 40. The attachment part 20 is fixed to a part where the through-hole 41 of the chassis 40 is formed, that is, the exposed portion of the rear surface part 32.

Furthermore, address electrodes (not shown) and their terminal parts (not shown) are provided at a front rim part of the rear surface part 32 for connecting with the terminal parts of the flexible board 11. The flexible board 11 is bent toward the chassis 40 and the retaining board 13 provided at the tip of the flexible board 11 is fixed to the attachment part 20 via the screw 25. The connector part 15 at the tip part of the flexible board 11 is electrically connected to the address electrode drive control circuit board 60. It is to be noted that the address driver circuit 12 including the address IC 12a may be provided at an inner side of the bent flexible board 11.

Accordingly, by having one end of the flexible board 11 of the address driver module 10 fixed to the rear surface part 32 and the other end also fixed to the rear surface part 32 via the attachment part 20, the thermal expansion coefficient can be uniform. Accordingly, the flexible board 11 and the its joint parts can be prevented from being broken (fractured) by a difference in the thermal expansion coefficients. Furthermore, since the rear surface part 32 is usually formed of glass, the flexible board 11 can be fixed to a material having a low thermal expansion coefficient and the stress applied to the flexible board 11 can be reduced. Accordingly, breakage and fracture can be prevented.

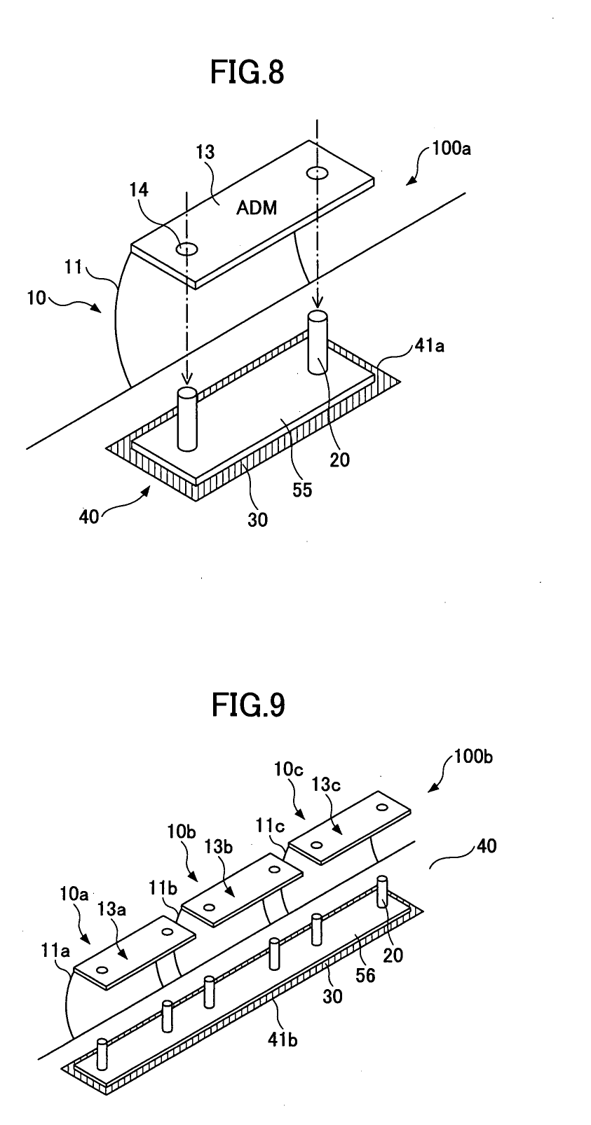

FIG. 8 is a perspective view showing the attachment part 20 of the plasma display apparatus 100 and a coupling part according to another embodiment of the present invention. In this case, a seat 55 is used as the coupling (fixing) part. In FIG. 8, a rectangular through-hole 41a is formed in the chassis 40. A portion of the panel substrate 30 is exposed in the rectangular through-hole 41a. Two attachment parts 20 are adjacently fixed to and coupled together by the seat 55 in the exposed portion of the panel substrate 30. That is, the two adjacent attachment parts 20 are provided on the front side of the seat 55 while the panel substrate 30 is fixed (in this example, adhesively fixed) to the back side of the seat 55. Accordingly, since the adhesively contacting area between the adjacent attachment parts 20 and the panel substrate 30 is greater compared to fixing each of the attachment parts 20 to the panel substrate 30, the attachment parts 20 can be fixed to the panel substrate 30 more securely and resistance against stress can be improved.

As one example for fixing the attachment parts 20 to the seat 55, holes can be formed in the seat 55 and the attachment parts 20 can be press fitted into the holes. This method may be used in a case where the seat 55 and the attachment parts 20 are made of different materials (e.g., a case where the seat 55 is made of aluminum or iron whereas the attachment parts 20 are made of brass). By using this method, the attachment parts 20 and the seat (coupling part) 55 can be formed as a united body. As another example, in a case where the seat 55 and the attachment parts 20 are made of the same material (e.g., iron), the seat 55 and the attachment parts 20 may be integrally molded from the beginning.

Accordingly, by providing the adjacent attachment parts 20 and the seat 55 serving as its coupling part at the exposed portion of the panel substrate 30, the heat resistance of the address driver module 10 can be improved along with further strengthening the fixed relationship between the exposed portion of the panel substrate 30 and the attachment parts 20.

In the embodiment shown in FIG. 8, since the attachments parts 20 corresponding to a single address driver module 10 are coupled together, resistance against stress for each address driver module 10 can be improved. It is to be noted that, although FIG. 8 shows an exemplary configuration of the address driver module 10 having a flexible board 11, a retaining board 13, and two through-holes 14 where screws 25 (not shown) are inserted and fastened to the through-holes 14, the address driver module 10 may be fixed to the attachment parts 20 by using other methods. Further, the attachment parts 20 may be formed, for example, in various shapes or with various materials. Furthermore, as described above in the embodiment of FIG. 4, the address driver module 10 may be attached without using the retaining board 13.

Next, a plasma display apparatus 100b according to another embodiment of the present invention is described with reference to FIG. 9. FIG. 9 is a perspective view showing the attachment part 20 of the plasma display apparatus 100b and a coupling part (in this example, seat 56) according to another embodiment of the present invention. In the example shown in FIG. 9, an array of three address driver modules 10a, 10b, 10c are arranged at an outer rim part of the chassis 40 while six adjacently arranged attachment parts 20 are provided on a single seat 56 in correspondence with the address driver modules 10a, 10b, 10c. A through-hole 41b having a size corresponding to the three address driver modules 10a, 10b, 10c is formed in the chassis 40, to thereby expose a part of the panel substrate 30 and fix the seat 56 and the six attachment parts 20 on the exposed part of the panel substrate 30.

Thus, as shown in FIG. 9, plural attachments parts 20 corresponding to the plural adjacently arranged address driver modules 10a, 10b, 10c can be coupled together by the seat 56 serving as a coupling part. Accordingly, the seat 56 not only can serve to the position of a single address driver module 10 but can also reliably secure the positions of plural adjacently arranged address driver modules 10. Thereby, strong durability can be attained for the entire plasma display apparatus 10b. Further, by increasing the contacting area between the seat 56 and the panel substrate 30, the panel substrate 30 can be supported and fixed more securely to the attachment parts 20.

Various methods may be used to fix the seat 56 to the attachment parts 20. For example, the attachment parts (e.g., brass) 20 may be pressingly fitted into plural holes formed in the seat 56 (e.g., aluminum or iron). In another example, both the seat 56 and the attachment parts 20 may be formed with the same material (e.g., iron) and integrally molded.

Although FIG. 9 shows three address driver modules 10a, 10b, 10c provided as a single block (set), the number of address driver modules provided as a single block is not limited to three. For example, five address driver modules may be provided as a single block. For example, in a 60 inch type plasma display apparatus 100b to which 15 address driver modules 10 are provided on each of the upper and lower sides of the plasma display panel 90 of the plasma display apparatus 10b, five blocks may be provided on each of the upper and lower sides where a single block has three address driver modules 10a, 10b, 10c as shown in FIG. 9. By increasing the number of address driver modules 10 assigned to a single block, the number of blocks of the plasma display panel 90 can be reduced. Accordingly, the steps of fixing the attachment parts 20 and the seat 56 to the exposed part of the panel substrate 30 can be reduced. Thus, the number of address driver modules 10 assigned to a single block can be determined taking the above factors into consideration.

Furthermore, various methods may be used to fix the address driver modules 10a, 10b, 10c to the attachment parts 20. For example, corresponding retaining boards 13a, 13b, 13c can be provided to the address driver modules 10a, 10b, 10c and screws (not shown) for fastening or crimping the retaining boards 13a, 13b, 13c to the attachment parts 20 can be used for fixing the address driver modules 10a, 10b, 10c to the attachment parts 20. Other alternative methods besides using the retaining boards 13a, 13b, 13c may also be used as long as the flexible board 11a, 11b, 11c of the address driver modules 10a, 10b, 10c can be fixed to the attachment parts 20.

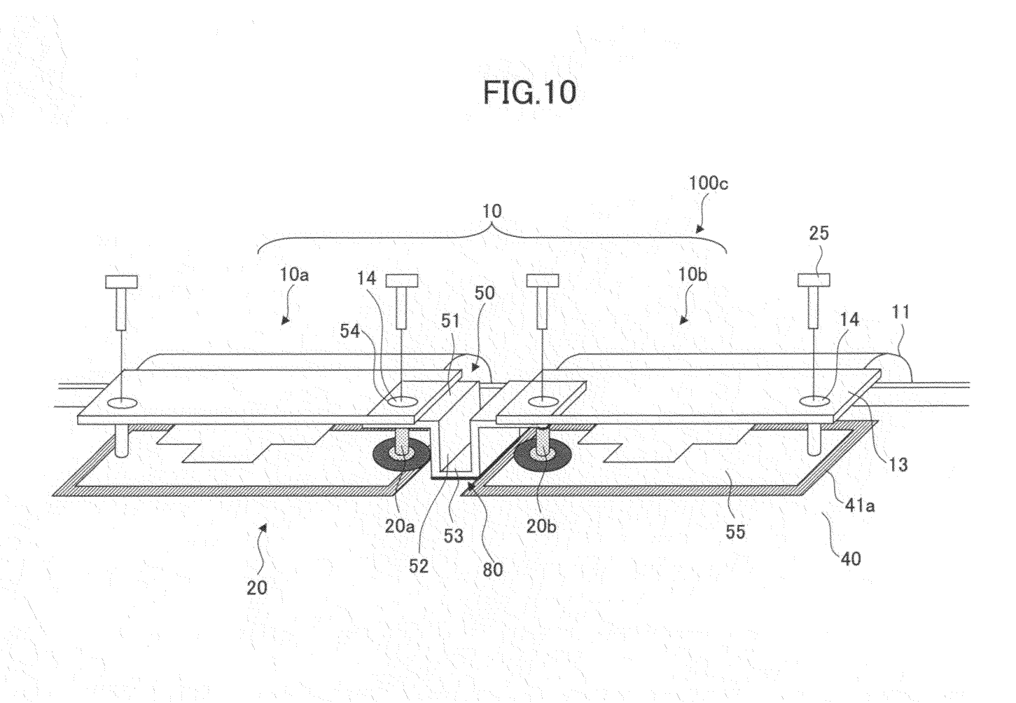

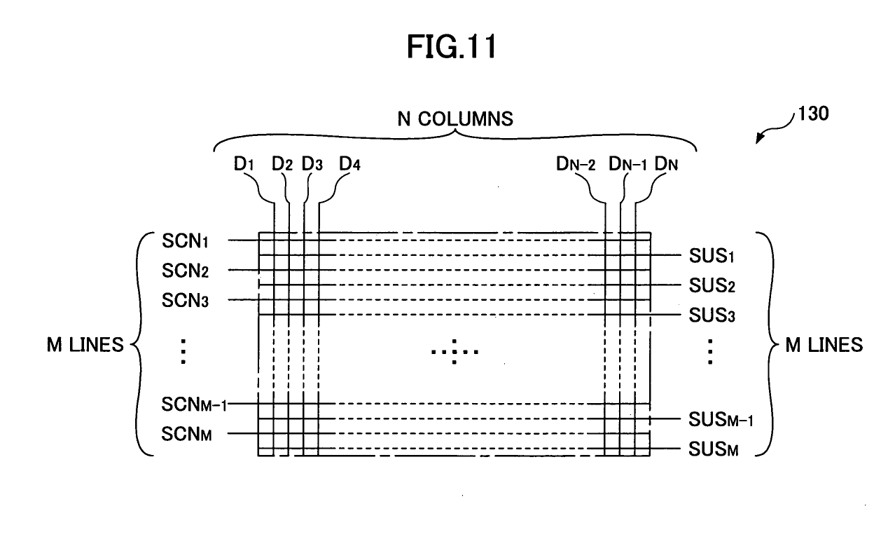

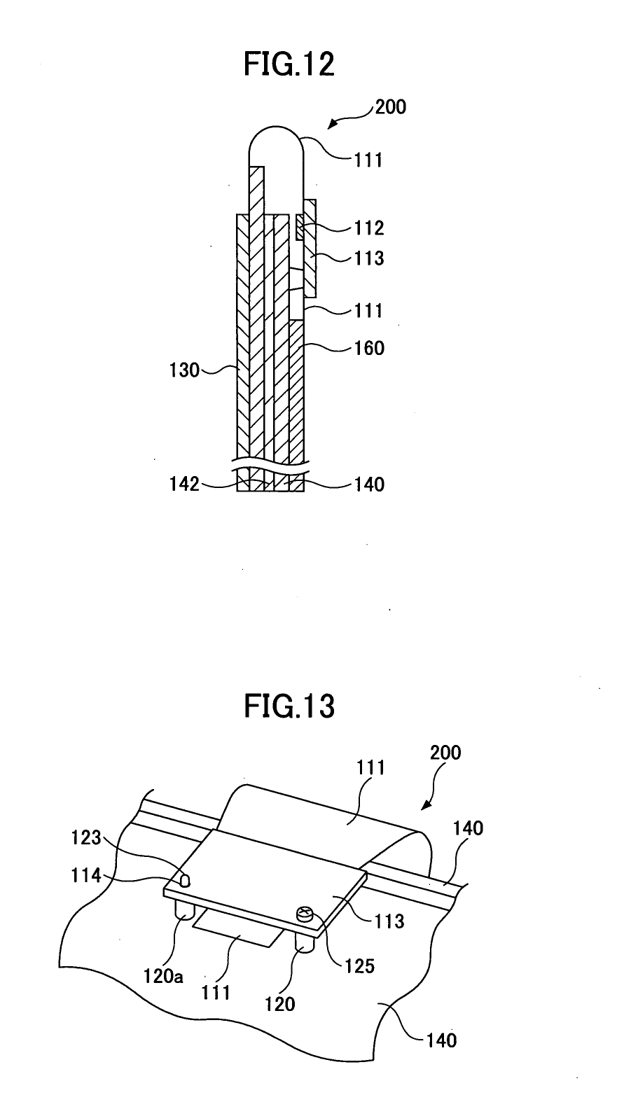

Next, a plasma display apparatus 100c according to another embodiment of the present invention is described with reference to FIG. 10. FIG. 10 is a perspective view showing a part for fixing a set of address driver modules 10 (hereinafter also referred to as “address driver module set”) in a plasma display apparatus 100c using a seat 55 and a supporting board 50 as a coupling (connecting) part.

In FIG. 10, through-holes 41a are provided in the chassis 40 in correspondence with each address driver module set 10. FIG. 10 shows a configuration of the address driver module set 10 where two attachment parts 20 are fixed to corresponding exposed parts of the panel substrate 30 and coupled by the seat 55. The seat 55 serves to increase the fixing strength between the attachment parts 20 and the panel substrate 30 and reinforce the attachment parts 20.

Furthermore, in FIG. 10, adjacently arranged attachment parts 20a, 20b fixed to corresponding adjacently arranged address driver modules 10a, 10b of the address driver module set 10 are coupled by the supporting board 50. The supporting board 50 serves to reinforce the adjacently arranged attachment parts 20a, 20b and to increase the coupling strength between the address driver modules 10a, 10b. Thereby, a strong durability can be attained for the entire plasma display apparatus 100c. In the configuration shown in FIG. 10, the chassis 40 remains provided between the adjacent address driver modules 10a, 10b without being removed by the through-hole 41. Therefore, by using a metal material having high electrical and thermal conductivity (e.g., aluminum) for the supporting board 50 and forming a bottom part 53 (a part of the supporting board 50 contacting the chassis 40) into a U-shape, the supporting board 50 can strengthen ground characteristics and improve heat releasing property as described above with FIG. 6.

By using both the seat 55 and the supporting board 50 as the coupling part, resistance against stress for each address driver module (including address driver modules 10a, 10b) of the address driver module set 10 can be improved by increasing the fixing strength between the attachment parts 20 and the panel substrate 30 via the seat 55. In addition, ground characteristics and heat releasing property can be improved by increasing the coupling strength between adjacently arranged address driver modules 10a, 10b with the supporting board 50.

It is to be noted that an electrically conductive gasket 80 may be provided between the bottom part 53 of the supporting board 50 and the chassis 40. Furthermore, retaining boards 13 may be used for fixing the address driver modules 10 to the attachment parts 20 by fastening the address driver modules 10 to the attachment parts 20 via through-holes 14, 54 formed in the retaining boards 13. As described above, other alternative methods may be used for fixing the address driver module 10 to the attachment parts 20.

Hence, with the plasma display apparatus according to the above-described embodiment of the present invention, the resistance against, for example, heat of the address driver modules can be improved. Further, the address driver module are fixed to a panel substrate having both ends formed of the same material, so that the amount of deformation in the ends are substantially the same in a case where thermal expansion occurs. Thus, the amount of stress applied to the address driver module can be reduced. Further, the attachment parts can be reinforced and the fixing strength between the attachment parts and the panel substrate can be increased by coupling adjacently arranged attachment parts.

Moreover, with the plasma display apparatus according to the above-described embodiment of the present invention, a seat is used as the coupling part having a front surface to which one or more adjacent attachment parts are attached and a rear surface to which the panel substrate is fixed (e.g., adhesively fixed). Thereby, the fixing and supporting strength between the attachment parts and the panel substrate can be increased and resistance against stress in the direction substantially parallel to the rim part (outer side) of the panel substrate. Furthermore, the seat according to an embodiment of the present invention may couple adjacently arranged attachment parts corresponding to a single address driver module. Thereby, the attaching strength of each address driver module can be increased. The seat according to an embodiment of the present invention may couple adjacent attachment parts corresponding to plural adjacently arranged address driver modules. Thereby, the coupling strength of the adjacently arranged address driver modules.

Moreover, with the plasma display apparatus according to the above-described embodiment of the present invention, the address driver module may have a retaining board provided at the vicinity of a front tip portion thereof, and the retaining board may be fixed to the attachment parts. Thereby, the fixing strength between the address driver modules and the panel substrate can be increased. Further, a material having high heat conductivity may be used for the retaining board, to thereby improve heat releasing property. Further, the attachment parts according to an embodiment of the present invention may be formed in a cylindrical shape. Thereby, the address driver module can be suitably spaced apart from the panel substrate, and the attachment part can be formed having a threaded configuration.

Moreover, with the plasma display apparatus according to the above-described embodiment of the present invention, the retaining board may include elliptical holes arranged in a longitudinal direction of the panel substrate so that the retaining board can be fixed to the attachment parts by fastening the attachment parts and corresponding elliptical holes with screws. By fixing the address driver module to the attachment parts in such a manner, resistance against stress in a direction substantially parallel to the longitudinal direction of the panel substrate can be improved in a case where the address driver module is provided above and below the panel substrate.

Further, the coupling part according to an embodiment of the present invention includes a supporting board coupling adjacently arranged address driver modules. Thereby, the coupling strength between adjacent driver modules can be directly increased by corresponding flexible boards instead of by the attachment parts. Further, the supporting board according to an embodiment of the present invention may include a bottom part and a side part that form a U-shape, in which the bottom part contacts the chassis or the coupling part. Thereby, the supporting board not only serves to couple adjacent flexible boards but also to reinforce the address driver modules with respect to the vertical (upper/lower) direction of the attachment part. Furthermore, the supporting board according to an embodiment of the present invention may be formed of a metal material, in which the bottom part of the supporting board contacts the chassis. This improves ground characteristics owing to the increased ground area with respect to the chassis. This also improves heat releasing property with respect to the chassis, to thereby improve the heat releasing property of the address drive module. Furthermore, the bottom part of the supporting board according to an embodiment of the present invention may contact the chassis or the panel substrate via a gasket. Thereby, reinforcing strength of the attachment parts, the ground characteristics, and the heat releasing property can be further improved.

Further, the present invention is not limited to these embodiments, but variations and modifications may be made without departing from the scope of the present invention.

The present application is based on Japanese Priority Application No. 2007-145518 filed on May 31, 2007, with the Japanese Patent Office, the entire contents of which are hereby incorporated by reference.

What is claimed is:

1. A plasma display apparatus comprising:
a panel substrate;
a chassis adhered to a rear surface of the panel substrate and supporting the panel substrate; and
a plurality of address driver modules arranged along a rim portion of the panel substrate, each address driver module including a flexible board and an address driver circuit provided on the flexible board and having one end fixed to a front surface rim part of the panel substrate;
wherein the chassis has at least one through-hole formed in a rim part of the chassis, the through-hole exposing a part of the panel substrate to which a plurality of attachment parts are fixed, the plural attachment parts including adjacently arranged attachments parts fixed to the panel substrate by a coupling part, wherein the other end of the address driver module is fixed to the plural attachment parts.

2. The plasma display apparatus according to claim 1, wherein the coupling part includes a seat having a front surface attached to the attachment part and a rear surface fixed to the panel substrate.

3. The plasma display apparatus according to claim 2, wherein the seat couples a set of adjacent of the attachment parts corresponding to a single one of address driver modules.

4. The plasma display apparatus according to claim 2, wherein the seat couples a plurality of sets of adjacent of the attachment parts corresponding to plural of the address driver modules.

5. The plasma display apparatus according to claim 1, wherein the address driver module has a retaining board provided at the vicinity of a front tip portion thereof, wherein the retaining board is fixed to the attachment parts.

6. The plasma display apparatus according to claim 1, wherein the attachment part has a cylindrical shape.

7. The plasma display apparatus according to claim 5, wherein the retaining board includes elliptical holes arranged in a longitudinal direction of the panel substrate, wherein the retaining board is fixed to the attachment parts by fastening the attachment parts and corresponding elliptical holes with screws.

8. The plasma display apparatus according to claim 1, wherein the coupling part includes a supporting board coupling adjacently arranged address driver modules.

9. The plasma display apparatus according to claim 8, wherein the supporting board 50 includes a bottom part and a side part that form a U-shape, wherein the bottom part contacts the chassis or the coupling part.

10. The plasma display apparatus according to claim 9, wherein the supporting board is formed of metal, wherein the bottom part contacts the chassis.

11. The plasma display apparatus according to claim 9, wherein the bottom part contacts the chassis or the panel substrate via a gasket.
